(19) United States
(12) Patent Application Publication
(10) Pub. No.: US 2026/0077604 A1
(43) Pub. Date: Mar. 19, 2026

(54) IMAGE FORMING APPARATUS

(71) Applicant: CANON KABUSHIKI KAISHA, Tokyo (JP)

(72) Inventor: KO HIRAI, Ibaraki (JP)

(21) Appl. No.: 19/324,725

(22) Filed: Sep. 10, 2025

(30) Foreign Application Priority Data
Sep. 13, 2024 (JP) 2024-158867

(51) Int. Cl. B41J 3/46; G03G 15/00; G03G 21/16; H04N 1/00

(52) U.S. Cl. CPC B41J 3/46; G03G 15/5016; G03G 21/1604; G03G 21/1647; H04N 1/00496

(57) ABSTRACT

An image forming apparatus includes an apparatus main body configured to form an image on a sheet, an operation unit arranged above the apparatus main body in a vertical direction, a frame constituting the apparatus main body, a support portion configured to mount the operation unit to the frame, and a unit arranged within an area below the operation unit in the vertical direction, wherein the unit comprises a mounting portion configured to fix the unit to the frame, wherein the mounting portion is fixed to the frame by a fixing device in a state where the mounting portion passes through a gap formed between the frame and the support portion, and wherein the fixing device that fixes the mounting portion is removable in a state in which the operation unit is mounted to the frame via the support portion.

### BACKGROUND OF THE INVENTION

### Field of the Invention

The present disclosure relates to an image forming apparatus, such as a printer, a copying machine, or a multifunction apparatus.

### Description of the Related Art

An image forming apparatus includes an operation unit as a user interface. The operation unit is equipped with input interfaces, such as various key buttons and a touch panel, and output interfaces, such as a display and a speaker. The operation unit is positioned at a location easily operated from an upper part and front part of a main body of the image forming apparatus in view of user operability. The image forming apparatus has a space for stacking a discharged sheet on which an image is formed, and this space is provided at a location where it is easy to access it from an upper part and front part of the main body of the image forming apparatus. In the image forming apparatus described in U.S. Pat. No. 9,527,692 and Japanese Patent Application Laid-open No. 2023-161112, an operation unit is arranged above a discharge space of a sheet, and a sheet is discharged from a back side to a front side of an apparatus main body. An operation unit is arranged in the either side of the right and left of a main body of the image forming apparatus.

In the operation units, the display parts tend to become larger due to an increase of information to be displayed on a display, an increase of information displayed thereon and adaption of touch panels. The display may be equipped with a mechanism that allows an angle of its display surface to be changed.

As to the apparatus main body of the image forming apparatus, there is a demand for space-saving by many users, especially working in small offices. The operation unit is required not to interfere with user operability or the miniaturization of the apparatus main body. For operability and miniaturization, in the image forming apparatuses described in U.S. Pat. No. 9,527,692 and Japanese Patent Application Laid-open No. 2023-161112, the operation unit is arranged so as to overlap the region of the image forming apparatus main body when viewed from above.

The image forming apparatus includes the image forming unit to form an image inside a support frame which constitute a casing of the image forming apparatus. The operation unit is attached to the support frame via an operation unit support portion. In Japanese Patent Application Laid-open No. 2023-161112, the operation unit is removed from the support frame before performing maintenance on the image forming unit. In this regard, removing the operation unit in order to access the image forming unit may reduce work efficiency.

### SUMMARY OF THE INVENTION

An image forming apparatus according to some embodiments of the present disclosure includes an apparatus main body configured to form an image on a sheet, an operation unit arranged above the apparatus main body in a vertical direction, a frame constituting the apparatus main body, a support portion configured to mount the operation unit to the frame, and a unit arranged within an area below the operation unit in the vertical direction, wherein the unit comprises a mounting portion configured to fix the unit to the frame, wherein the mounting portion is fixed to the frame by a fixing device in a state where the mounting portion passes through a gap formed between the frame and the support portion, and wherein the fixing device that fixes the mounting portion is removable in a state in which the operation unit is mounted to the frame via the support portion.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is a configuration diagram of the image forming apparatus.

FIG. 3 is a configuration diagram of the image forming apparatus.

FIG. 4 is a configuration diagram of the image forming apparatus.

FIG. 5 is a configuration diagram of the image forming apparatus.

FIG. 6 is a configuration diagram of the image forming apparatus.

FIG. 7 is an explanatory view of a configuration for attaching an operation unit.

FIG. 8 is an explanatory view of a configuration for attaching the operation unit.

FIG. 9 is an explanatory view of a configuration for attaching the operation unit.

FIG. 10 is an explanatory view of a configuration for attaching the operation unit.

FIG. 11 is an explanatory view of a configuration for attaching the operation unit.

FIG. 12 is an explanatory view of a configuration of peripheral of an operation unit support.

### DESCRIPTION OF THE EMBODIMENTS

Now, description of at least one embodiment of the present disclosure with reference to the accompanying drawings is given. However, the dimensions, materials, shapes, relative arrangements, etc., of components described in the following embodiments should be appropriately modified according to a configuration of an apparatus to which the present disclosure is applied and various conditions, thus, the scope of the present disclosure should not be limited to the description.

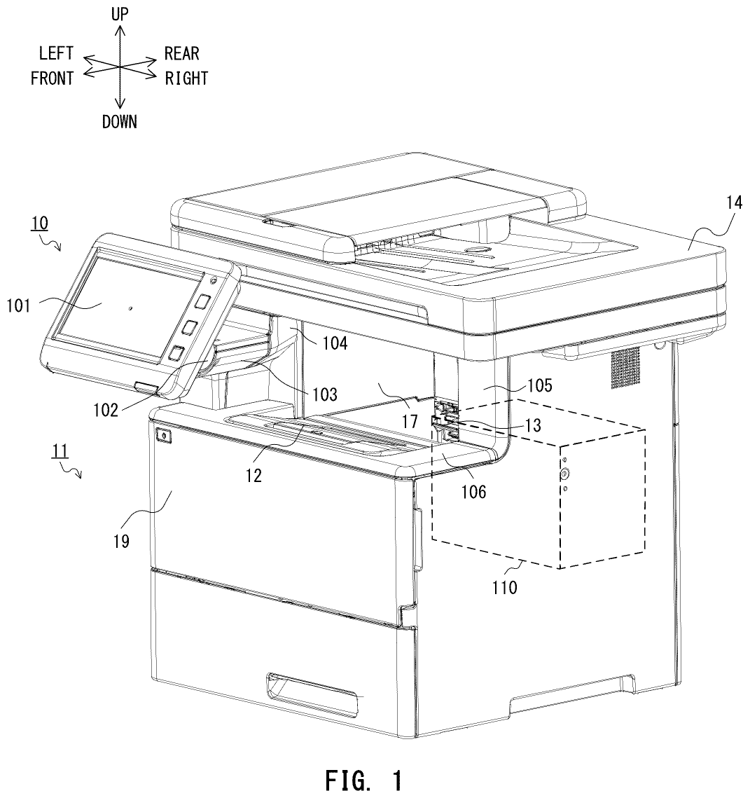

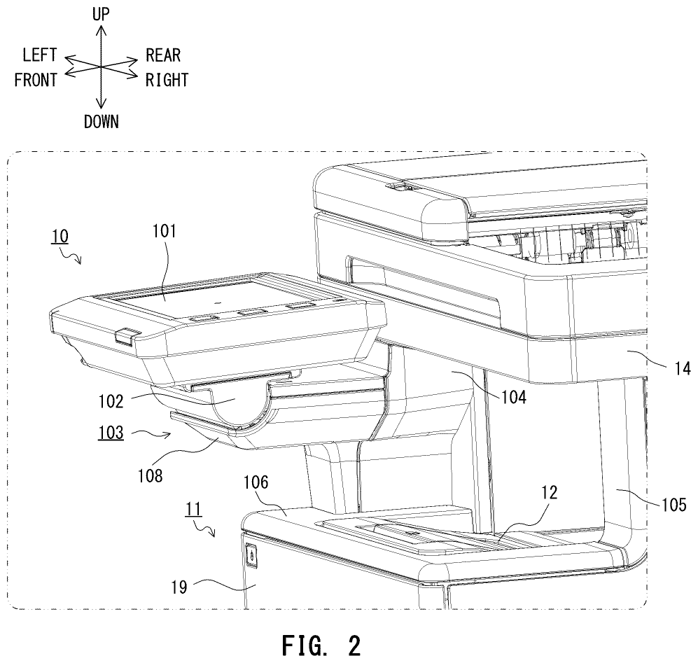

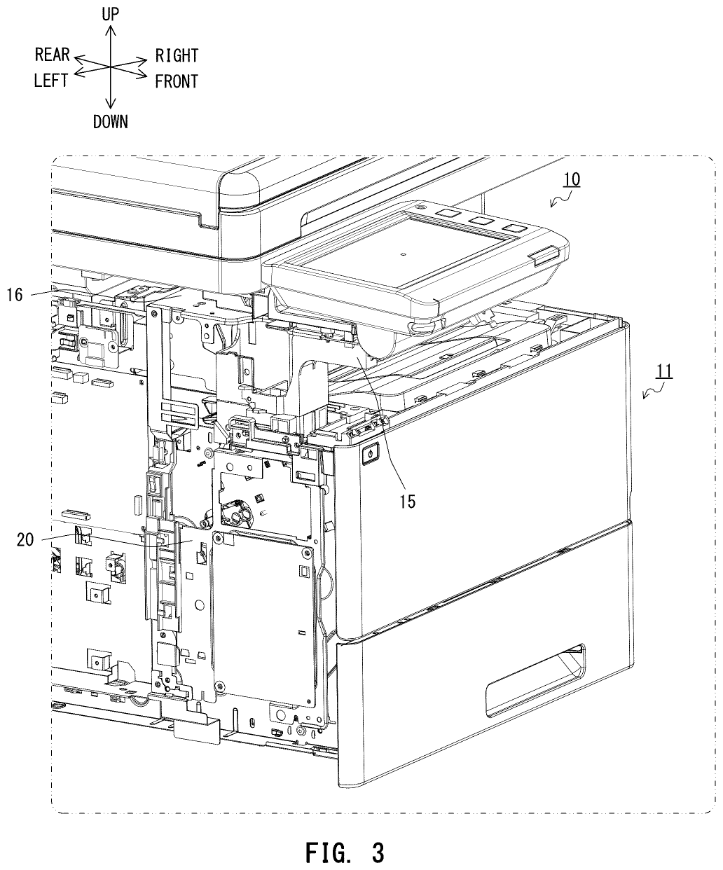

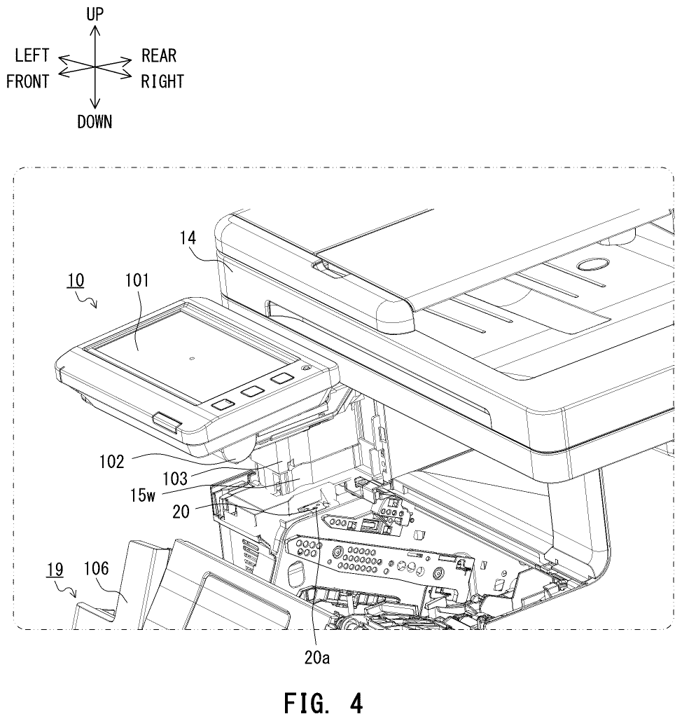

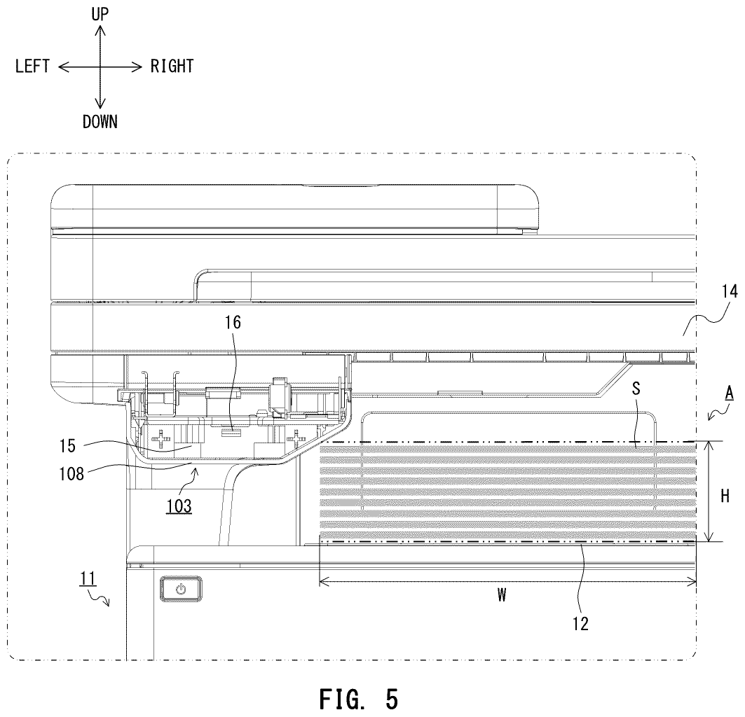

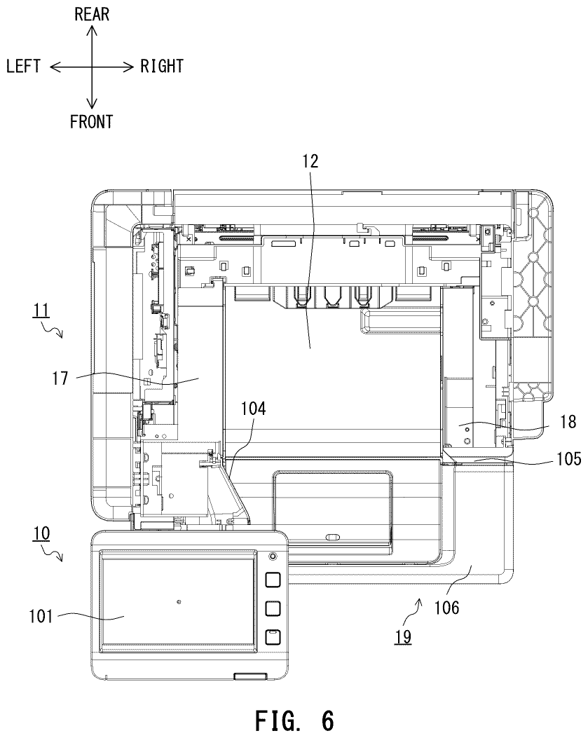

FIGS. 1-6 are configuration diagrams of an image forming apparatus according to the at least one embodiment. FIG. 1 is a perspective view of the image forming apparatus when viewed from right front. FIG. 2 is an expansion perspective view of an operation unit portion. FIG. 3 is a perspective view of the image forming apparatus with its left outer cover removed. FIG. 4 is an expansion perspective view of the operation unit portion with opening/closing cover on the front side of the image forming apparatus opened. FIG. 5 is a cross-sectional view representing a position and shape of an operation unit support portion. FIG. 6 is a top view of a main body of the image forming apparatus as viewed from the top in the vertical direction.

The image forming apparatus includes an image forming unit 110, which serves as an image former, to form an image on a sheet inside an apparatus main body 11. The image forming apparatus has an operation unit 10, which serves as an operation device, attached to an upper front side of the apparatus main body 11. The operation unit 10 is a user interface that includes input interfaces, such as various key buttons and a touch panel, and an output interfaces, such as a display 101 and a speaker. An image reading apparatus 14 to read images from a document is located at an upper portion of the apparatus main body 11. The apparatus main body 11 includes a discharge tray 12, a discharge portion 13, an operation unit support portion 15, an operation unit support plate 16, a main body first frame 17, a main body second frame 18, an opening/closing cover unit 19, and a board support plate 20. The image forming apparatus comprises an operation unit support portion cover 103 (hereinafter referred to as “support cover 103”), a main body first frame cover 104 (hereinafter referred to as “first frame cover 104”), a main body second frame cover 105 (hereinafter referred to as “second frame cover 105”), and an opening/closing cover 106.

The sheet S on which an image has been printed by the image forming unit 110 is discharged from the discharge portion 13 toward the front from the rear of the apparatus main body 11 to the discharge tray 12. The discharged sheet S is stacked on the discharge tray 12. The discharge tray 12 is provided in a discharge space between the upper end of the apparatus main body 11 and the image reading apparatus 14.

The opening/closing cover unit 19 is mounted so as to be openable and closable relative to the apparatus main body 11 at a position at a front end of the apparatus main body 11. The opening/closing cover unit 19 is provided to allow access to internal units of the apparatus main body 11. Note that the opening/closing cover 106 is attached to the opening/closing cover unit 19. In FIG. 2, the opening/closing cover unit 19 is in a closed state, and in FIG. 4, the opening/closing cover unit 19 is in an open state.

As shown in FIG. 1 and FIG. 6, the main body first frame 17 and the main body second frame 18 are positioned at the upper portion of the apparatus main body 11. The image reading apparatus 14 is supported at the upper portion in the vertical direction of the apparatus main body 11 by the main body first frame 17 and the main body second frame 18. The image reading apparatus 14 is also supported by the operation unit support portion 15 and the operation unit support plate 16 (see FIG. 5). The operation unit support portion 15, the operation unit support plate 16, and the main body first frame 17 are support members which support the image reading apparatus 14 at the left side of the discharge tray 12. The main body second frame 18 is a support member that supports the image reading apparatus 14 at the right side of the discharge tray 12. The first frame cover 104 is attached to the main body first frame 17, and the second frame cover 105 is attached to the main body second frame 18. In this configuration, the image reading apparatus 14 is supported above the discharge tray 12 in the vertical direction.

As illustrated in FIG. 2, the operation unit 10 is arranged at a position above the apparatus main body 11 and also front side of the image reading apparatus 14. The operation unit 10 is supported, in an up-down direction, by an operation unit support portion 15 and an operation unit support plate 16 (see FIG. 3). The support cover 103 is attached to the operation unit support portion 15. The operation unit 10 includes an operation unit hinge 102. The operation unit 10 is rotatable by the operation unit hinge 102, and a display surface of the display 101 can be adjusted to a predetermined angle. The movable range of the operation unit 10 is at least from an angle at which the display surface of the display 101 faces forward as shown in FIG. 1 to an angle at which it faces upward as shown in FIG. 2.

As shown in FIG. 2 and FIG. 5, when viewed from above in the vertical direction, a portion of the support cover 103 and the display 101 are arranged to overlap with the discharge tray 12 in a left-right direction of the apparatus main body 11. Hereinafter, the length in the up-down direction between the sheet stacking surface of the discharge tray 12 and a lower end of the support cover 103 is described as “maximum sheet stacking height H”. Sheets discharged onto the sheet stacking surface may curl. For this reason, the maximum sheet stacking height H is defined as a sum of a height of the sheets when the maximum number of sheets are stacked on the discharge tray 12 and the maximum curl height of the discharged sheet. The maximum curl height of the discharged sheet is the maximum value of the curl of the sheet, which is generated when the sheet is discharged onto the discharge tray 12, in the up-down direction, and varies depending on conditions such as the type of the sheet, temperature, and humidity. Thus, in the at least one embodiment, it is desirable to optimize sheet conveyance settings and image forming settings for each product so that the maximum curl height of the discharged sheet satisfies curl height specifications defined for each product.

Hereinafter, the maximum sheet size stacked on the sheet stacking surface of the discharge tray 12 is defined as “maximum sheet stacking width W”. Further, the area (discharge space) enclosed by the maximum sheet stacking height H and the maximum sheet stacking width W is defined as the maximum sheet stacking area A. As described above, since the operation unit 10 is arranged at a position above (and also front of the image reading apparatus 14) the apparatus main body 11, accessibility to the sheets discharged onto the maximum sheet stacking area A is reduced. Further, it is difficult to miniaturize the entire image forming apparatus since the operation unit 10 is arranged above the apparatus main body 11 to prevent the operation unit 10 from interfering with a path of the sheet when discharged onto the sheet stacking surface.

As shown in FIG. 3, the board support plate 20 is arranged inside the apparatus main body 11 below the operation unit 10. The board support plate 20 can be accessed by removing the cover on the left side of the apparatus main body 11. For example, when performing maintenance on the board support plate 20, the cover on the left side of the apparatus main body 11 is removed.

### Configuration of the Operation Unit

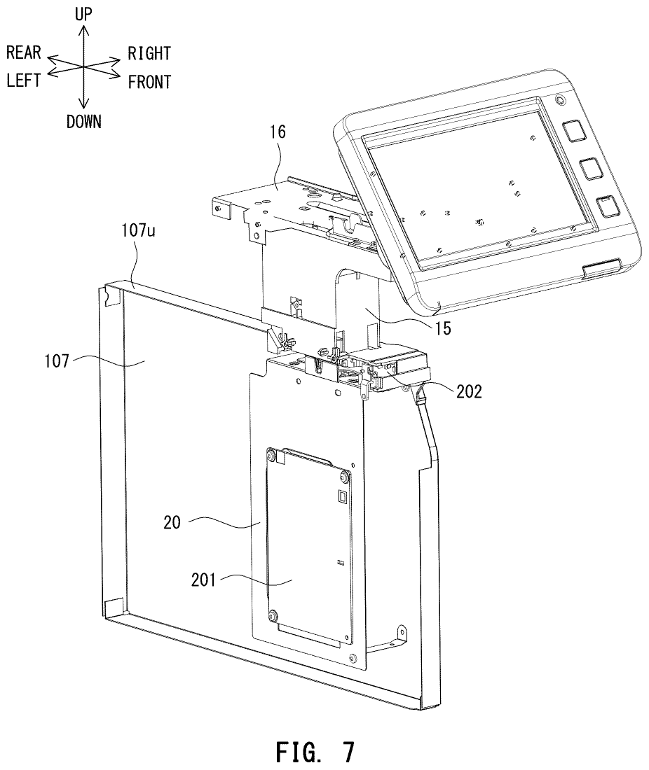

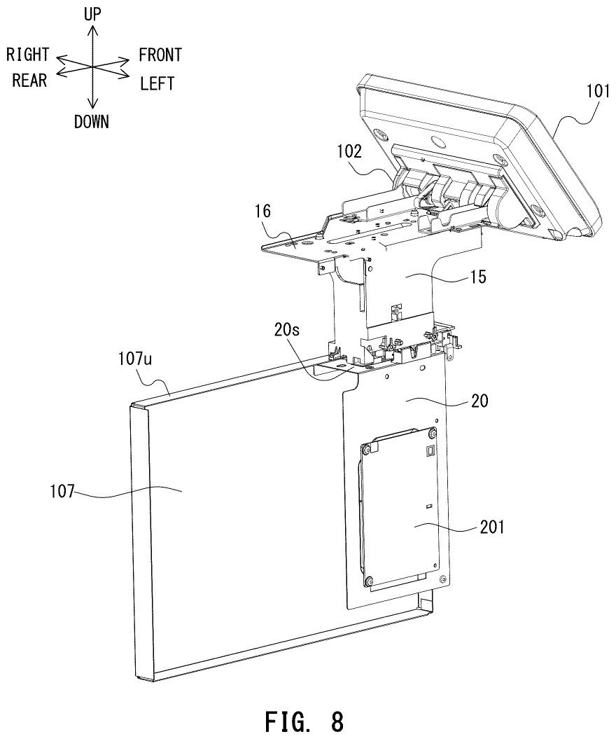

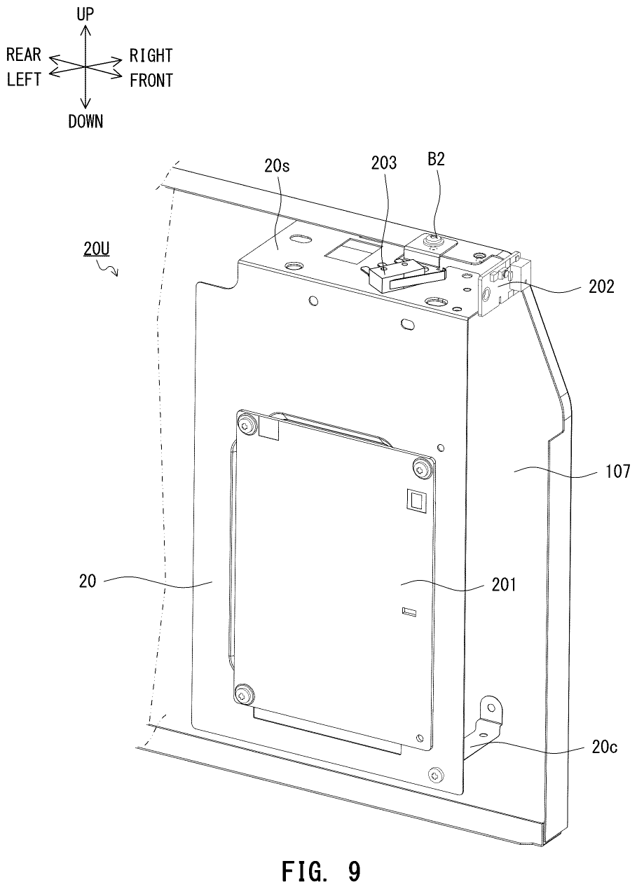

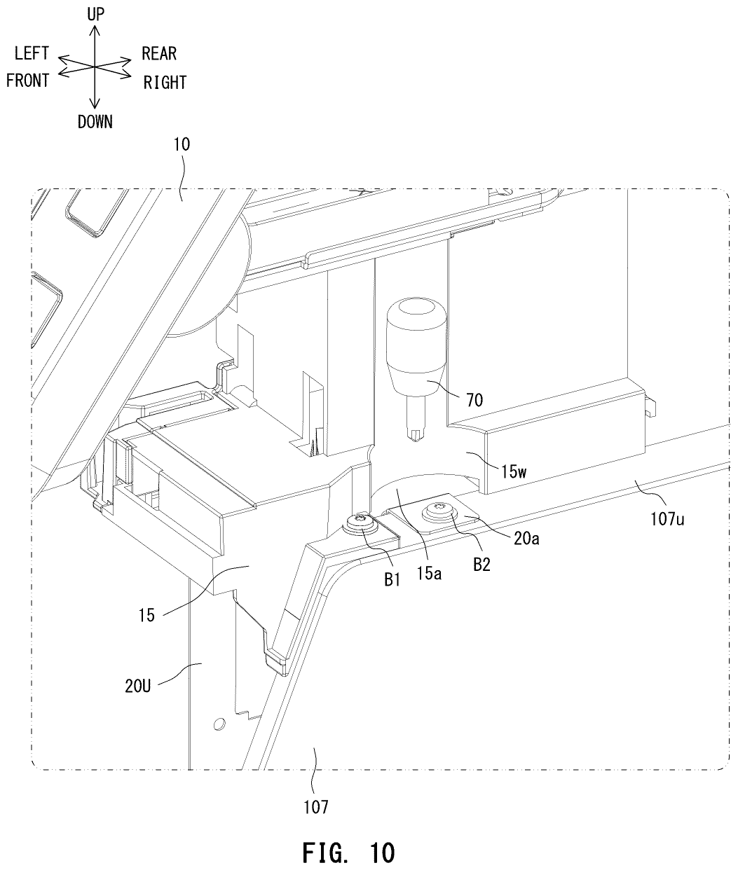

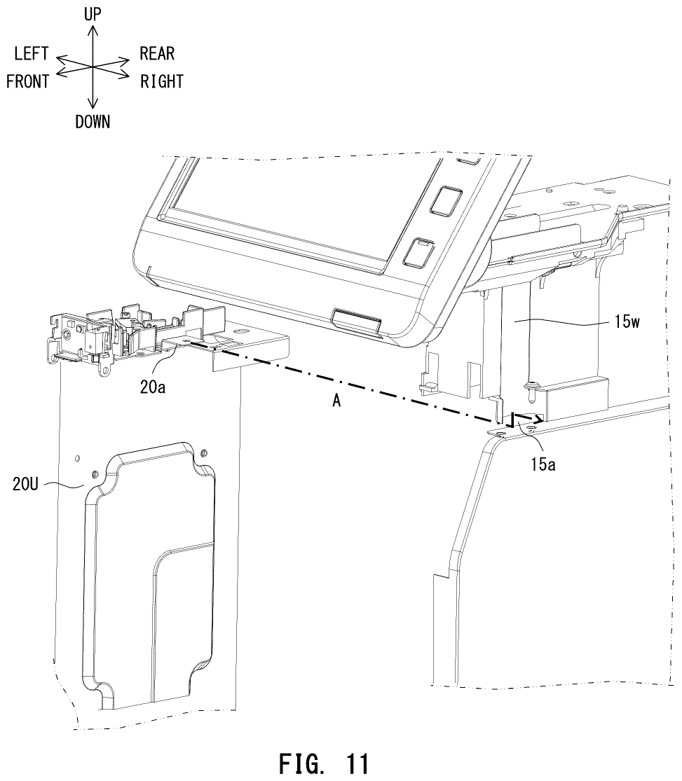

FIGS. 7-11 are explanatory configuration views of mounting the operation unit 10. FIG. 7 is a perspective view of the operation unit 10 from left front side. FIG. 8 is a perspective view of the operation unit 10 from left rear side. FIG. 9 is a configuration view of the board support plate 20. FIG. 10 is an explanatory view of a configuration of peripheral of an operation unit support portion 15. FIG. 11 is an explanatory view of an assembly configuration of a control unit.

The operation unit support portion 15 is fixed with a screw B1 to an upper edge portion 107u of a main body left frame 107 at its right end (FIG. 10) and is arranged with its left end landing on an upper surface 20s of the board support plate 20 (FIG. 7 and FIG. 8). The main body left frame 107 is provided on the left side of the apparatus main body 11 and constitutes the casing of the apparatus main body 11.

As illustrated in FIG. 9, a control board 201 is mounted to a left side surface of the board support plate 20. The control board 201 is equipped with a control device for controlling the operation of the image forming unit 110, for example. On the upper surface 20s of the board support plate 20, via a switch holder (not shown), a soft switch 202 is mounted at the front and an interlock switch 203 is mounted at the rear. A control unit 20U is constituted by the board support plate 20, the control board 201, the soft switch 202, and the interlock switch 203. The lower side of the board support plate 20 is provided with a connection plate 20c, and the board support plate 20 is fixed to the main body left frame 107 by the connection plate 20c.

As shown in FIG. 10, an upper arm portion 20a is provided to the board support plate 20, and the upper arm portion 20a is fixed to the upper edge portion 107u of the main body left frame 107 by a fixing device (here, a screw B2). The upper arm portion 20a serves as a mounting portion, and the upper edge portion 107u serves as an attaching portion. A curved surface 15w is provided to a first area of the operation unit support portion 15. The first area is an area where the upper arm portion 20a of the board support plate 20 is fixed with the screw B2. The curved surface 15w needs to be large enough to secure space for using a tool (a stubby screwdriver) 70 for removing and attaching the screw B2. In addition, in a part of the first area, a gap is created between the operation unit support portion 15 and the main body left frame 107 due to the curved surface 15w.

In a case where the is attached the control unit 20U to the main body left frame 107, as shown by an arrow A in FIG. 11, the upper arm portion 20a of the board support plate 20 is fixed in a state in which it passes through the gap between the operation unit support portion 15 and the main body left frame 107 from the left side to the right side and fixed. To provide the gap between the operation unit support portion 15 and the main body left frame 107, the operation unit support portion 15 has a recess 15a which forms the curved surface 15w in the vicinity of the mounting position of the board support plate 20 (first area). The upper arm portion 20a of the board support plate 20 passes through the gap formed by the recess 15a, and is exposed at the upper edge portion 107u of the main body left frame 107 and fastened to the upper edge portion 107u in the vertical direction with screw B2 using a tool 70. When the control unit 20U is removed from the main body left frame 107 for maintenance, etc., the screw B2 is removed with the tool 70, then, the upper arm portion 20a of the board support plate 20 is pulled out to the left. The position where the upper arm portion 20a overlaps the position of the curved surface 15w when viewed from the left-right direction, therefore, the upper arm portion 20a is inserted and withdrawn in the left-right direction.

With this configuration, the size of the main body of the image forming apparatus can be suppressed since the control unit 20U is accommodated within the area below the operation unit 10 as viewed from above the image forming apparatus. In addition, when the control unit 20U is removed for maintenance, etc., it is not necessary to remove the operation unit 10 and the operation unit support portion 15. Therefore, workability can be maintained. Furthermore, space for using the tool 70 for removing and attaching the screw B2, which is for fixing the control unit 20U to the main body left frame 107, is secured by the curved surface 15w of the operation unit support portion 15. The curved surface 15w is formed by concavely curving a portion of the inner side surface of the operation unit support portion 15. This prevents a decrease in rigidity of the operation unit support portion 15.

### Modification Example

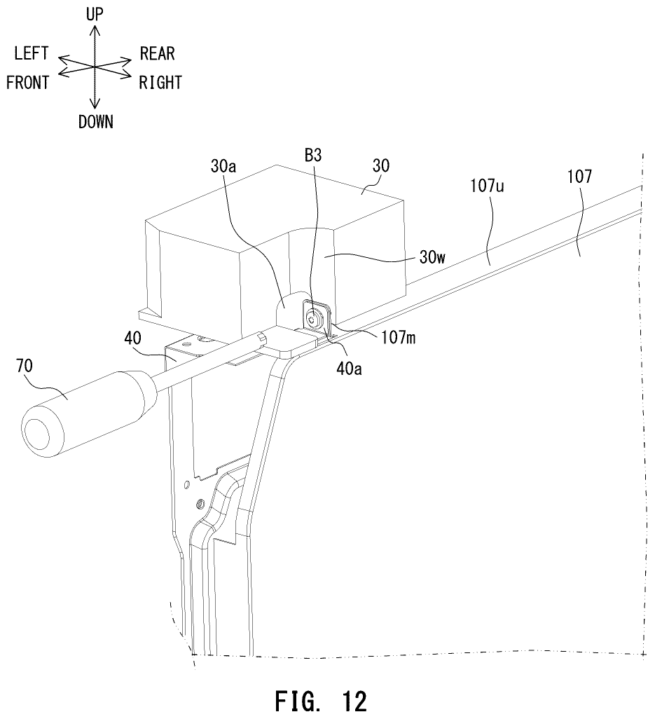

FIG. 12 is an explanatory view of a modification example of a configuration of peripheral of an operation unit support. In the configuration shown in FIG. 10, the fastening direction of the screw B2 is from the upper side to the lower side in the vertical direction, whereas in the configuration shown in FIG. 12, the fastening direction of a fixing device (here, a screw B3) is from the front side to the rear side in a horizontal direction. The differences between the configuration shown in FIG. 10 and the configuration shown in FIG. 12 are described below.

A board support plate 40 is attached to an attachment portion 107m of the main body left frame 107 by the screw B3. The attachment portion 107m is a projecting piece, which serves as a projection portion, provided in the upward direction in the vertical direction from the upper edge portion 107u of the main body left frame 107, and has a hole for attaching a screw. The fastening direction of the screw B3 is horizontal, unlike the vertical direction (up and down direction) in FIG. 10. The screw B3 is screwed in from the front toward the rear. For this reason, the surface of a mounting portion 40a of the board support plate 40 and a surface of the attachment portion 107m of the main body left frame 107 are aligned in the front-rear direction.

Since the fastening direction of the screw B3 is horizontal, the side surface of an operation unit support portion 30 is open toward the front and has a curved surface 30w provided on the rear side. If the screw B3 can be attached, the curved surface 15w of the same shape as in FIG. 10 may be provided on the right side surface of the operation unit support portion 30. In any case, the side surface of the operation unit support portion 30 may be of a shape that allows the screw B3 to be easily attached and removed using the tool 70. Even with this configuration, the size of the image forming apparatus main body can be kept small and workability during maintenance can be maintained.

The mounting portion 40a of the board support plate 40 is a projecting piece provided in the upward direction in the vertical direction from the upper arm portion 20a, and a screw hole for mounting screw is provided for screwing the screw B3. The other configurations and shapes of the mounting portion 40a of the board support plate 40 are the same as the configurations described in FIGS. 1 to 11, for example, the mounting portion 40a passes through a gap created by a recess 30a of the operation unit support portion 30 from left to right and mounted to the underside of the operation unit 10. In the configuration shown in FIG. 12, since the screw B3 is screwed in from the front to the rear, a screw hole of the mounting portion 40a face forward. Since space is secured in front of the screw hole of the mounting portion 40a, there is no restriction on the length of the tool 70, and improved workability is obtained.

When accessing the fixing device of the control unit 20U with the tool 70, the opening/closing cover 106 of the opening/closing cover unit 19 is opened as shown in FIG. 4. By opening the opening/closing cover 106, an opening is secured for the tool 70 to access the fixing device.

For example, in the configuration shown in FIG. 10, the tool 70 accesses the screw B2 through an opening from the lower side of the operation unit 10 shown in FIG. 4, and fastens the upper arm portion 20a of the board support plate 20 to the upper edge portion 107u of the main body left frame 107. The curved surface 15w prevents the tool 70 from interfering with the support cover 103 (operation unit support portion 15).

In the configuration shown in FIG. 12, the tool 70 accesses the screw B3 through an opening from the lower front side of the operation unit 10 shown in FIG. 4, and fastens the mounting portion 40a of the board support plate 40 to the attachment portion 107m of the main body left frame 107. Since the right side surface of the operation unit support portion 30 is open toward the front and has the curved surface 30w on the rear side, the tool 70 does not interfere with the support cover 103 (operation unit support portion 30).

As described above, in the image forming apparatus of the present disclosure, the size of the main body is suppressed because the control unit 20U is accommodated within the area below the vertical direction of the operation unit 10. The control unit 20U is mounted to the apparatus main body 11 by movement in a horizontal direction (left-right direction or front-rear direction) that is different from the vertical direction. When the control unit 20U is removed from the apparatus main body 11, it is moved in the horizontal direction in the opposite direction to the direction in which it was installed. For this reason, it is not necessary to remove the operation unit 10 when attaching or removing the control unit 20U, which improves workability for maintenance and other operations.

In addition, the operation unit support portion 15 has space in the first area including the mounting position of the control unit 20U so that fixing devices (screws, nuts, etc.) can be easily accessed when the tool 70 is attached to the control unit 20U. In the examples shown in FIGS. 10 and 12, the operation unit support portions 15 and 30 are formed with curved surfaces 15w and 30w. Note that if space is available for using the tool 70, the shape is not limited to the curved surfaces 15w and 30w. According to the present disclosure, there is provided an image forming apparatus in which the reduction of the workability is suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-158867, filed Sep. 13, 2024, which is hereby incorporated by reference herein in its entirety.

What is claimed is:

1. An image forming apparatus comprising:
an apparatus main body configured to form an image on a sheet;
an operation unit arranged above the apparatus main body in a vertical direction;
a frame constituting the apparatus main body;
a support portion configured to mount the operation unit to the frame; and
a unit arranged within an area below the operation unit in the vertical direction,
wherein the unit comprises a mounting portion configured to fix the unit to the frame,
wherein the mounting portion is fixed to the frame by a fixing device in a state where the mounting portion passes through a gap formed between the frame and the support portion, and
wherein the fixing device that fixes the mounting portion is removable in a state in which the operation unit is mounted to the frame via the support portion.

2. The image forming apparatus according to claim 1, wherein the support portion has a shape that secure space for using a tool to fix the mounting portion to the frame.

3. The image forming apparatus according to claim 1, wherein the unit is configured such that horizontal movement of the unit causes the mounting portion to pass through the gap.

4. The image forming apparatus according to claim 3, wherein the support portion has a recess portion to create the gap between the support portion and the frame.

5. The image forming apparatus according to claim 4, wherein the support portion includes a first region that forms a portion of the gap, and the first region has a curved shape due to the recess.

6. The image forming apparatus according to claim 5, wherein a position where the mounting portion is fixed overlaps the position of the curved shape of the support portion when viewed from a horizontal direction.

7. The image forming apparatus according to claim 1, wherein, in the unit, the mounting portion is fixed to an upper edge portion of the frame by the fixing device.

8. The image forming apparatus according to claim 7, wherein the mounting portion is fastened in the vertical direction by the fixing device to the upper edge portion.

9. The image forming apparatus according to claim 1,
wherein the mounting portion comprises a projecting portion which projects in a first direction,
wherein the frame comprises an attachment portion arranged in the first direction, and
wherein the projecting portion of the mounting portion is fixed to the attachment portion by the fixing device.

10. The image forming apparatus according to claim 9, wherein the first direction is an upward direction in the vertical direction.

11. The image forming apparatus according to claim 10, wherein the mounting portion is fastened in a horizontal direction by the fixing device to the attachment portion.
